(19) United States
(12) Patent Application Publication
(10) Pub. No.: US 2024/0320768 A1
(43) Pub. Date: Sep. 26, 2024

(54) Running track designed to restore and promote sustainable use of terrestrial ecosystem and system for facilitating support to enhance operations

(71) Applicant: Jason Priyam Modawal, Charlotte, NC (US)

(72) Inventor: Jason Priyam Modawal, Charlotte, NC (US)

(21) Appl. No.: 18/641,491

(22) Filed: Apr. 22, 2024

(51) Int. Cl. G06Q 50/16

(52) U.S. Cl. CPC G06Q 50/165

(57) ABSTRACT

Running track designed to restore and promote sustainable use of terrestrial ecosystem. Running track comprised of a central area used for conservation efforts, a oval-shaped running path, extension paths and fencing. Running track is referred to as a communal preservation space.

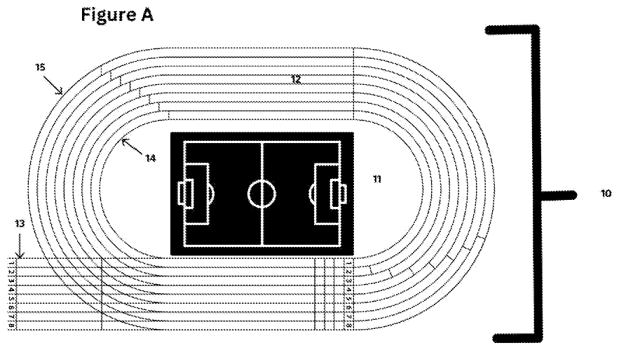

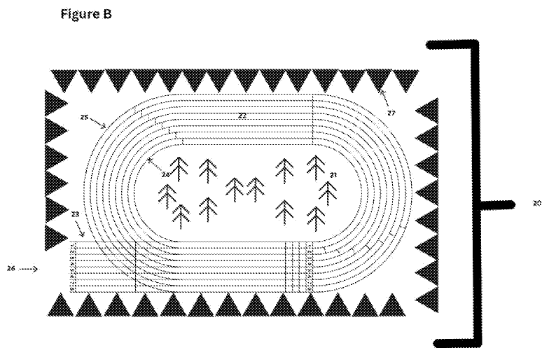

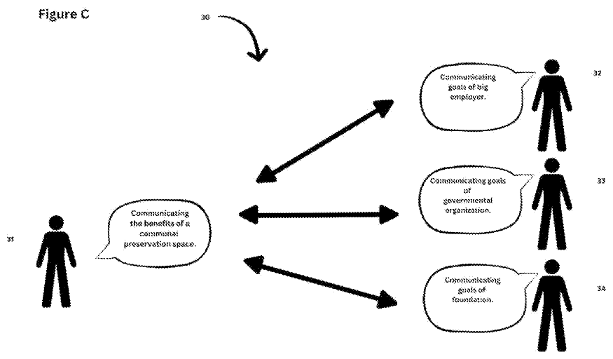

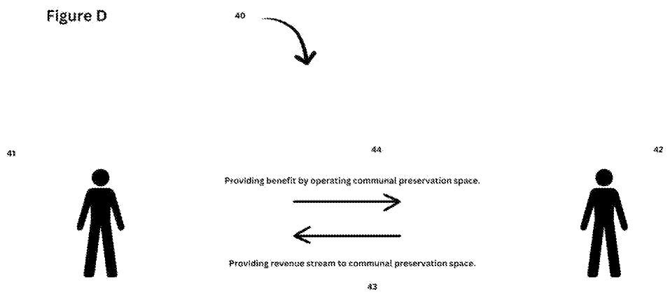

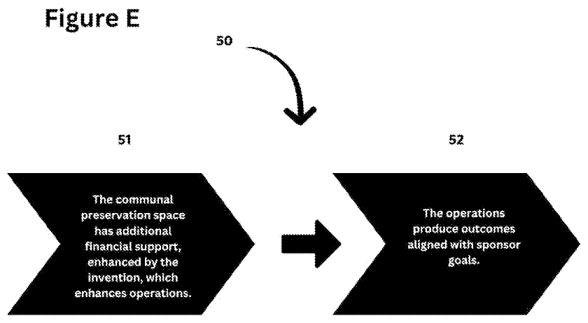

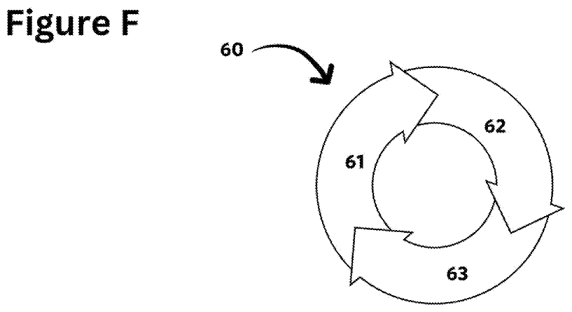

### FIELD

The invention relates to a running track, and more specifically to a running track designed to restore and promote sustainable use of terrestrial ecosystem and related system for facilitating financial support to enhance operations.

### BACKGROUND

The United Nations Sustainable Development Goals (2015), which are a blueprint for peace and prosperity for people and the planet, now and into the future, solidify the need for Life On Land (Goal 15) which is defined as to “Protect, restore and promote sustainable use of terrestrial ecosystems, sustainably managed forests, combat desertification, and halt and reverse land degradation and halt biodiversity loss.”

Yet, as of 2023 in the United States, data shows “34% of plants and 40% of animals are at risk of extinction, and 41% of ecosystems are at risk of range-wide collapse”.

A major driver of extinction risk is land conversion. Land conversion is defined herein as the conversion of natural land to vacant land or when vacant land is altered for the purpose of development. There are many different forms of development (Commercial, Multifamily, Residential, etc.) and in general, traditional Methods of development usually involve a site clearing. Site clearings directly kill native plant and animal systems. Furthermore, lack of root systems present may cause water table to rise. This rise in the water table also brings salt to the surface, which degrades the soil. Thus, a need for development designed to restore and promote sustainable use of terrestrial ecosystem exist.

One such type of Commercial Development is a running track. Running tracks, in general, comprise of a oval-shaped path, and a central area of artificial turf used as a athletic field.

The above information disclosed in this background section is for enhancement of understanding the background of this invention, and therefore, it may contain information that does not constitute prior art.

### BRIEF SUMMARY

The present invention provides a running track designed to restore and promote sustainable use of terrestrial ecosystem and related system for facilitating financial support to enhance operations.

According to the one implementation of the present invention, a exemplary running track with enhancements, referred to herein as a communal preservation space, is provided. More specifically, the communal preservation space comprises of a oval-shaped running path extending around a central area used for conservation efforts. Width of the running path can be determined by taking the distance between the inner and outer edge. Additionally, running path may have extension areas that extend from oval-shaped running path to entrance. Additionally, the communal preservation space may be enclosed by fencing.

According to another implementation of the present invention, a system for facilitating financial support to enhance operation is provided. Specifically, this system begins by communicating to enhance awareness of the communal preservation space. Next, the system solidifies partnerships for the communal preservation space. Next, the system controls the operations of the communal preservation space for sustainment.

Other features of the present invention will be apparent from the accompanying drawings and from the detailed description that follows.

### BRIEF DESCRIPTION OF THE DRAWINGS

Figure A illustrates a exemplary traditional running track 10.

Figure B illustrates a exemplary running track with enhancements 20, in accordance with one or more of the enclosed embodiments, also referred to as a communal preservation space, designed to restore and promote sustainable use of terrestrial ecosystem.

Figure C is a flow diagram 30 depicting communicating awareness of a communal preservation space, an activity of a system for facilitating financial support to enhance operations.

Figure D is a flow diagram 40 depicting solidifying sponsorships for a communal preservation space, an activity of a system for facilitating financial support to enhance operations.

Figure E is a flow diagram 50 depicting controlling the operations of a communal preservation space for sustainment, an activity of a system for facilitating financial support to enhance operations.

Figure F is a flow diagram 60 depicting a system for facilitating financial support to enhance operations.

### DETAILED DESCRIPTION OF THE PREFERRED EMBODIMENTS

Figure B illustrates a exemplary running track with enhancements 20, in accordance with one or more of the enclosed embodiments, also referred to herein as a Communal Preservation Space, designed to restore and promote sustainable use of terrestrial ecosystem . The exemplary running track with enhancements 20 comprises of a central area used for conservation efforts 21. The running path 22 is oval-shaped and is formed around the central area used for conservation efforts 21. The distance between the inner edge 24 and the outer edge 25 represent the width of the running path 22. The exemplary running track with enhancements 20 may have extension areas 23 that extend from running path 22 to an entrance 26. Fencing 27 may be included to surround the exemplary running track with enhancements.

Figure C is a flow diagram 30 depicting communicating awareness of a communal preservation space, an activity of a system for facilitating financial support to enhance operations. In this activity, the representative of the communal preservation space (e.g., Founder, conservationist, employee, etc.) 31, is communicating awareness of the communal preservation space 20. In one embodiment, the representative would communicate benefits to a variety of potential sponsors with goals in the community, represented by sponsor A 32, Sponsor B 33, and Sponsor C 34.

Sponsor A 32 is a big employer in the community and has objectives in community health and marketing opportunities. As the representative 31 operates a communal preservation space 20, giving awareness to the sponsor represents a viable actualization of the sponsors' community health goals by the embodiments running path 22 and actualization of the marketing goals by association with the communal preservation space 20.

Sponsor B 33 is a governmental organization whose goal is to fund community projects associated with Goal 15 of the United Nations Sustainable Development Goals which is defined as to “ Protect, restore and promote sustainable use of terrestrial ecosystems, sustainably managed forests, combat desertification, and halt and reverse land degradation and halt biodiversity loss.” As the representative 31 operates a communal preservation space 20 giving awareness to the sponsor represents a viable actualization of the sponsors' goal to fund community projects associated with Goal 15 by the embodiments' central plot used for conservation efforts 21.

Sponsor C 34 is a foundation in the community and has objectives in education. As the representative 31 operates a communal preservation space 20 giving awareness to the sponsor represents a viable actualization of the sponsors' education goals by the embodiments' central plot used for conservation efforts 21 and running path 22 which could be used for an educational program.

Figure D is a flow diagram 40 depicting solidifying sponsorships for a communal preservation space, an activity of a system for facilitating financial support to enhance operations. In this activity, the representative of the communal preservation space (e.g., Founder, conservationist, employee, etc.) 41, is solidifying sponsorships for a communal preservation space. In one embodiment, there would be a sponsor 42, providing a revenue stream to the communal preservation space 43 as the operations of the communal preservation space fulfill the goals and provide the benefit 44 to the sponsor 42.

Figure E is a flow diagram 50 depicting controlling the operations of a communal preservation space for sustainment, an activity of a system for facilitating financial support to enhance operations. In this activity, the representative of the Communal Preservation Space (e.g., Founder, conservationist, employee, etc.) 51 is controlling the operations of a communal preservation space for sustainment. In one preferred embodiment, the communal preservation space 20 has additional financial support, enhanced by the invention, which enhances operations 52. From there, the operations produce outcomes aligned with sponsor goals 53.

Figure F is a flow diagram 60 depicting a system for facilitating financial support to enhance operations. This system comprising of 3 activities. The activities are communicating awareness of a communal preservation space 61, solidifying sponsorships for a communal preservation space 62, and controlling the operations of a communal preservation space for sustainment 63. These activities represent facilitation of financial support, which are enhanced by the invention. After a period of time, facilitation of financial support may become actual sponsorships providing financial support.

While the present invention has been described in connection with specific preferred embodiments, variations of these embodiments will be apparent. Therefore, the scope of the appended claims should not be limited to the preceding description.

What is claimed is:

1. A running track, comprising
a central area used for conservation efforts
a running path which forms an oval-shaped imprint around the central area used for conservation efforts and includes an inner and outer edge
extension paths extending from the running path to an entrance
fencing surrounding the running track.

2. A system, comprising
communicating, by one or more processes, awareness of the communal preservation space,
solidifying, by one or more processes, partnerships for the communal preservation space, and
controlling, by one or more processes, the operations of the communal preservation space for sustainment.
